(19) United States
(12) Patent Application Publication
(10) Pub. No.: US 2025/0139105 A1
(43) Pub. Date: May 1, 2025

(54) QUERY-AWARE EXTRACTIVE HIERARCHICAL SUMMARIZATION

(71) Applicant: GOOGLE LLC, Mountain View, CA (US)

(72) Inventors: Pranesh Srinivasan, Sunnyvale, CA (US); Sameer Panwar, Fremont, CA (US); Krishna Rakeshkumar Shukla, New York, NY (US); Laichee Man, Burlingame, CA (US); Bharath Santosh, San Jose, CA (US)

(21) Appl. No.: 18/496,281

(22) Filed: Oct. 27, 2023

(51) Int. Cl. G06F 16/2457; G06F 16/248

(52) U.S. Cl. CPC G06F 16/24578; G06F 16/248; G06F 16/334; G06F 16/345

(57) ABSTRACT

A method is disclosed for generating an extractive summary of a resource responsive to a query. Extractive resources can be used to rank responsive resources and/or to enhance a search result. An example method can involve determining relevance scores for sentences within the resources, generating extractive summaries from sentences with the highest relevance scores, and calculating a resource relevance scores for each resource based on the extractive summary. The resources are then ranked based on the relevance scores and a search result page generated. In some implementations, a machine learned model is used to generate the relevance score and/or the extractive summary.

### BACKGROUND

Information extraction from documents is a fundamental task in natural language processing (NLP). It is the process of identifying and extracting key information from a document, such as facts, events, opinions, and entities. This information can then be used for a variety of downstream tasks, such as question answering (including identifying and scoring relevant documents), summarization, and machine translation.

### SUMMARY

Implementations relate to generating an extractive summary for a resource based on a query and/or to ranking documents based on relevance of an extractive summary. In some implementations, the extractive summary can be used as a response to the query, e.g., as a short answer or rich snippet. In some implementations, a model can be trained to generate an extractive summary for a resource given a query and the resource. In some implementations, the extractive summary can be used for ranking/re-ranking resources responsive to a search. In some implementations, a model can be trained to provide a ranking score based on an extractive summary. Implementations use a method that hierarchically analyzes resources determined to be responsive to a query and identifies the portions (e.g., paragraphs, passages, sections) most relevant to the query. The method may then analyze the sentences within some of the most relevant portions to identify relevance of each sentence to the query. Sentences that are identified as most relevant within the analyzed portions can be concatenated together, in the order in which they appear in the resource, to generate an extractive summary. In some implementations, an ellipsis may be added between sentences in the extractive summary that meet a distance criterion/distance criteria, e.g., sentences that are located in different portions, are sufficiently separated by a distance measure, etc. The extractive summary can be scored for relevance to the query and that score can be used to rank/re-rank resources for a search result. In some implementations, the extractive summary, the query, and the resource's contents can be used to train a model to generate the extractive summary given the query and the resource. In some implementations, the extractive summary, the query, the resource's contents, and the relevance score for the extractive summary can be used to train a model to provide a relevance score for the resource, based on a predicted extractive summary, given the query. The use of a model can speed the generation of an extractive summary and/or the relevance score based on the extractive summary, so that it can scale to responding in real-time to queries.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example environment in which improved techniques described herein may be implemented.

FIG. 2 is a diagram that illustrates an example extractive summary system, according to disclosed implementations.

FIG. 3 is a diagram that illustrates another example extractive summary system, according to disclosed implementations.

FIG. 4 is a diagram that illustrates an example method for generating and using extractive summaries, according to disclosed implementations.

FIG. 5 is a diagram that illustrates an example of a distributed computer device that can be used to implement the described techniques.

### DETAILED DESCRIPTION

Implementations relate to a system that improves the quality of a search result for complex queries by including an extractive summary or by ranking documents based on an extractive summary. Many queries are factual queries, which ask for information about a particular entity, e.g., who is the third US president?, who wrote The Hobbit, or how tall is the Eiffel Tower? These queries can be answered with a factual statement, e.g., identified in a resource and/or via a fact repository such as a knowledge graph. Complex queries pose questions that cannot be answered via a fact repository. Such questions may be asked in a yes/no manner, but the answer is not an attribute/fact about an entity. Some example complex queries include how long can meat be stored in a freezer?, what are the core arguments of Range by David Epstein?, and Can I grow saffron at home? Answering complex queries requires information extraction from resources that might include relevant information. Currently, search systems identify resources likely relevant to a query and even identify a most relevant portion of the resource for presentation to a user, but this process fails to capture the hierarchical structure of information in the resource and can lead to an incomplete answer to the query and/or a less relevant resource being ranked higher than a resource that more completely answers the query. While large language models can summarize a resource, this process is slow, taking hundreds to thousands of milliseconds per resource. In other words, this solution does not scale to a search engine's production environment, which handles billions of queries and where users expect search results within a few seconds. Summary generation over top ranked resources (e.g., thirty, fifty, etc.) resources that are responsive to a query is computationally prohibitive and too slow.

To address the technical problem of capturing the hierarchical structure of information in a resource that is responsive to a complex query, implementations extract relevant passages from a given resource and generate an extractive summary against the query. The extractive summary is not a generative summary, or in other words a summary generated by a large language model, such as BARD or CHAT-GPT; instead the extractive summary includes sentences that are identified as relevant to the query and extracted, as they appear in the resource's content, and concatenated tighter in the order they appear in the resource. This extractive summary can be generated in a few milliseconds, e.g., 3-5 ms. The extractive summary focuses on key parts (sentences) of the resource that are relevant to the user's query and includes the key parts no matter where they occur in the resource. Thus, a sentence from a paragraph at the beginning of a resource and the end of a resource may be included because both were found to be relevant to the query. This allows context from the whole resource to be presented in context with relevant information.

The extractive summaries of resources that are responsive to a query may be used to re-rank the resources. In other words, a current process that determines the relevance of a section of a resource to a query may be used to determine a relevance of (i.e., a relevance score for) the extractive summary to the query. This relevance score for the extractive summary can be used to re-rank the resources before a search result page is generated. This ensures that the resource that most completely answers the query is ranked highest, even if the answer appears in disjoint sections of the resource.

In some implementations, a model may be trained to generate the extractive summary, the relevance score for the extractive summary, or both given a query and a resource (as used herein, reference to a resource is understood to refer to any manner in which a resource's content can be accessed, so giving a resource to a model can include providing the content of the resource or can include providing an identifier of a resource that can be used to access the resource's content). A machine-learned model trained to give an extractive summary relevance score for a resource for a given query can provide the relevance score five to ten times faster than a non-model solution, which helps scale this solution.

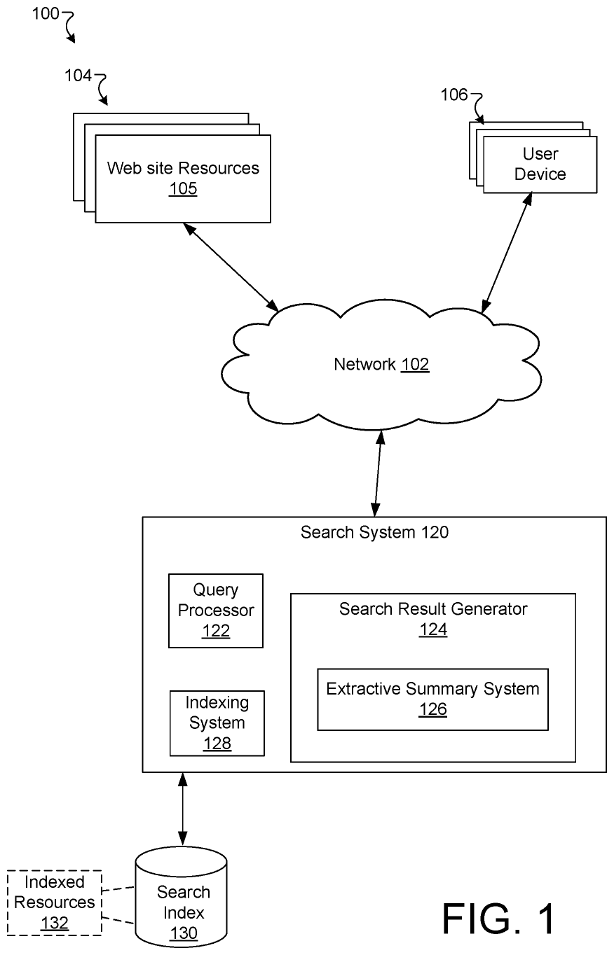

FIG. 1 is a diagram that illustrates an example environment 100 in which improved techniques described herein may be implemented. In the example of FIG. 1, a search result generator 124 of a search system 120 includes (e.g., uses, has access to) an extractive summary system 126. In the example of FIG. 1 the search system 120 is described as an Internet search engine, but implementations are not limited to Internet search engines and the disclosed techniques can be applied in any type of search system that responds to queries based on resource content. As used herein, resources can refer to any content accessible to a search engine. Thus, resources include webpages, images, documents, media, etc.

With continued reference to FIG. 1, a search system 120 provides search services. The example environment 100 includes a network 102, e.g., a local area network (LAN), wide area network (WAN), the Internet, or a combination thereof, connects web sites 104, user devices 106, and the search system 120. In some examples, the network 102 can be accessed over a wired and/or a wireless communications link. For example, mobile computing devices, such as smartphones can utilize a cellular network to access the web sites 104 and/or the search system 120. In some examples, the search system 120 can access the web site 104 via the Internet. The environment 100 may include millions of web sites 104 and user devices 106. In some implementations, the indexing system 128, query processor 122, and search result generator 124 may be co-located, e.g., at a server, which may be a distributed server. In some implementations, one or more of the indexing system 128, the query processor 122, and/or the search result generator 124 may be remote from but communicatively coupled with each other, e.g., at different servers that communicate with each other.

In some examples, a web site 104 is provided as one or more resources 105 associated with an identifier, such as domain name, and hosted by one or more servers. An example web site is a collection of web pages formatted in an appropriate machine-readable language, e.g., hypertext markup language (HTML), that can contain text, images, multimedia content, and programming elements, e.g., scripts. Each web site 104 is maintained by a publisher, e.g., an entity that manages and/or owns the web site. Web site resources 105 can be static or dynamic. In some examples, a resource 105 is data provided over the network 102 and that is associated with a resource address, e.g., a uniform resource locator (URL). In some examples, resources 105 that can be provided by a web site 104 include web pages, word processing documents, and portable document format (PDF) documents, images, video, and feed sources, among other appropriate digital content. The resources 105 can include content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources 105 over the network 102. Example user devices 106 include personal computers, mobile computing devices, e.g., smartphones, wearable devices, and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device, as are wearables and other smart devices such as smart speakers. A user device 106 typically includes a user application, e.g., a web browser, to facilitate the sending and receiving of data over the network 102.

The user device 106 may include, among other things, a network interface, one or more processing units, memory, and a display interface. The network interface can include, for example, Ethernet adaptors, Token Ring adaptors, and the like, for converting electronic and/or optical signals received from the network to electronic form for use by the user device 106. The set of processing units include one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

In some examples, to facilitate searching of resources 105, the search system 120 includes an indexing system 128 identifies the resources 105 by crawling and indexing the resources 105 provided on web sites 104. The indexing system 128 may index data about and content of the resources 105, generating search index 130. In some implementations, the fetched and indexed resources 105 may be stored as indexed resources 132. In some implementations, the search index 130 and/or the indexed resources 132 may be stored at the search system 120. In some implementations, the search index 130 and/or the indexed resources 132 may be accessible by the search system 120. In some implementations (not shown), the search system 120 may have access to a separate fact repository that can be accessed to provide factual responses to a query and/or to help with ranking resources responsive to a query.

The user devices 106 submit search queries to the search system 120. In some examples, a user device 106 can include one or more input modalities. Example input modalities can include a keyboard, a touchscreen, a mouse, a stylus, and/or a microphone. For example, a user can use a keyboard and/or touchscreen to type in a search query. As another example, a user can speak a search query, the user speech being captured through the microphone, and processed through speech recognition to provide the search query.

The search system 120 may include query processor 122 and/or search result generator 124 for responding to queries issued to the search system 120. In response to receiving a search query, the query processor 122 may process (parse) the query and access the search index 130 to identify resources 105 that are relevant to the search query, e.g., have at least a minimum specified relevance score for the search query. Processing the query can include applying natural language processing techniques and/or template comparison to determine a type of the query. The type may be a factual query. The type may be a complex query. The type may be an opinion query. The resources searched, the ranking applied, and/or the search result elements included in a search result page may be dependent on the type of the query and/or the type of the user device 106 that issued the query.

The search system 120 may identify the resources 132 that are responsive to the query and generate a search result page. The search result page includes search results and can include other content, such as ads, entity (knowledge panels), onebox answers, entity attribute lists (e.g., songs, movie titles, etc.), short answers, generated responses (e.g., from a large language model), other types of rich results, links to limit the search to a particular resource type (e.g., images, travel, shopping, news, videos, etc.), other suggested searches, etc. Each search result corresponds to a resource available via a network, e.g., via a URL/URI/etc. The resources represented by search results are determined by the search result generator 124 to be top ranked resources that are responsive to the query. In other words, the search result generator 124 applies a ranking algorithm to the resources to determine and order in which to provide search results in the search result page. A search result page may include a subset of search results initially, with additional search results (e.g., for lower-ranked resources) being shown in response to a user selecting a next page of results (e.g., either by selecting a ‘next page’ control or by continuous scrolling, where new search results are generated after a user reaches and end of a currently displayed list but continues to scroll).

Each search result includes a link to a corresponding resource. Put another way, each search result represents/is associated with a resource. The search result can include additional information, such as a title from the resource, a portion of text obtained from the content of the resource (e.g., a snippet), an image associated with the resource, etc., and/or other information relevant to the resource and/or the query, as determined by the search result generator 124 of the search system 120. In some implementations, the search result may include a snippet from the resource and an identifier for the resource. For example, where the query was issued from a device or application that received the user query via voice, the search result may be a snippet that can be presented via a speaker of the user device 106. The search result generator 124 may include a component configured to format the search result page for display or output on a user device 106. The search system 120 returns the search result page to the query requestor. For a query submitted by a user device 106, the search result page is returned to the user device 106 for display, e.g., within a browser, on the user device 106.

In disclosed implementations, the search result generator 124 includes an extractive summary system 126. The extractive summary system 126 may be used by the search result generator 124 to rank or re-rank resources responsive to a complex query. The search result generator 124 uses the extractive summary system 126 to generate a snippet for one or more of the responsive resources. In some implementations, the extractive summary system 126 may include an extractive summary model. The extractive summary model may be a machine learned model trained to provide an extractive summary, a score for an extractive summary, or both an extractive summary and a score for the extractive summary given a query and a resource (e.g., the content of the resource), as described herein.

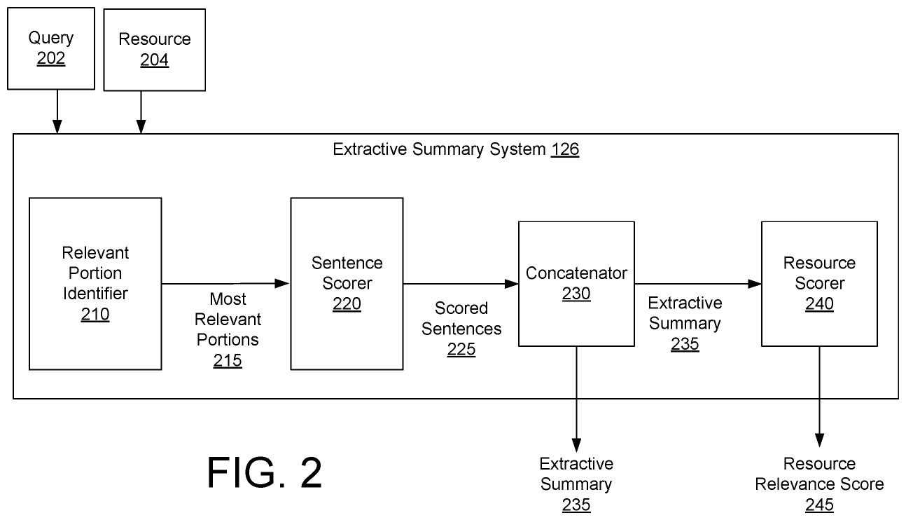

FIG. 2 is a diagram that illustrates an example extractive summary system 126, according to disclosed implementations. In some implementations, the extractive summary system 126 is configured to generate an extractive summary for a resource and query. In some implementations, the extractive summary system 126 is configured to generate an extractive summary relevance score for a resource and query. In some implementations, the extractive summary system 126 is configured to generate an extractive summary and the extractive summary relevance score for a resource and query. In some implementations, the extractive summary relevance scores can be used to re-rank top-ranked resources that are identified as responsive to a query. The number of top-ranked resources for which an extractive summary relevance score is computed may be implementation dependent. In some implementations, resources must have a relevance score that meets a threshold before an extractive summary relevance score is calculated for the resource. In some implementations, any resource ranked in the top n resources for a query may have an extractive summary relevance score calculated by the extractive summary system 126. In some implementations, a search result generator 124 may use the extractive summary generated for a resource in a search result page.

The extractive summary system 126 operates on a given query 202 and resource 204. The extractive summary system 126 can include relevant portion identifier 210. The relevant portion identifier 210 is configured to identify portions (sections, paragraphs, passages, etc.) of the resource 204 that are most relevant to the query 202. In some implementations, the relevant portion identifier 210 may be a service of the search system 120. In such implementations, the extractive summary system 126 may provide the service (the relevant portion identifier 210) with the resource identifier of the resource 204 and the query 202 and may request a number of (e.g., two, three, etc.) top relevant portions of each resource 204. In some implementations, the extractive summary system 126 may request the entire relevant portion be returned. In some implementations, extractive summary system 126 may be configured to determine the top relevant portions. The relevant portion identifier 210 may use known or later developed techniques for identifying top relevant portions. The relevant portion identifier 210 may assign a relevance score to each portion, i.e., a portion relevance score. The portion relevance scores may be used to determine (identify) the most relevant portions 215 for the resource 204 given the query 202. The most relevant portions 215 may include all portions with a portion relevance score that meets a threshold (e.g., a relevant portion threshold). The most relevant portions 215 may include a predetermined number of portions (e.g., three, four, six, etc., represented by n), regardless of the portion relevance score. In some implementations, the most relevant portions 215 may include up to n portions with portion relevance scores that meet the threshold. In some implementations, the most relevant portions 215 are returned to the extractive summary system 126 based on parameters the extractive summary system 126 provides to the relevant portion identifier 210.

The extractive summary system 126 includes a sentence scorer 220. The sentence scorer 220 is configured to determine a sentence relevance score for each portion in the most relevant portions 215. As used herein, a sentence can include any delimited text, such as text that appears in a table row, text that appears in as a list item, etc.

The extractive summary system 126 includes a concatenator 230. The concatenator 230 is configured to take the scored sentences 225 (which represent sentences in the most relevant portions 215) and generate an extractive summary 235 from the scored sentences 225. The concatenator 230 may use a predetermined number of sentences in generating the extractive summary 235. The concatenator 230 may use any sentence with a sentence relevance score that meets a threshold (e.g., a sentence threshold) to generate the extractive summary 235. The concatenator 230 may use a combination of the predetermined number and the sentence threshold to generate the extractive summary 235. The concatenator 230 may concatenate the sentences of the scored sentences 225 used to generate the extractive summary 235 in the order in which they appear in the resource. Put another way, the sentences are not ordered by sentence relevance score; instead, the concatenator 230 may preserve the order of the sentences in generating the extractive summary 235, which preserves the coherence and information flow of the resource.

In some implementations, the concatenator 230 may determine whether two sentences meet a distance criterion (or criteria). For example, if two sentences appear in different portions, this may meet the distance criterion. As another example, if two sentences are separated by a minimum number of words but appear in the same portion, this may meet the distance criterion. If two sentences that are to be included in the extractive summary 235 meet the distance criterion the concatenator 230 may include an ellipsis between the sentences. For example, if the sentence “In just one year, 1918, the average life expectancy in America plummeted by a dozen years.” and the sentence “In just 10 days, over 1000 Philadelphians were dead, with another 200,000 sick.” are top-scoring sentences to be included in the extractive summary 235, when the two sentences appear in the same passage and/or within some minimum number of words of each other, the concatenator 230 may concatenate the sentences as “In just one year, 1918, the average life expectancy in America plummeted by a dozen years. In just 10 days, over 1000 Philadelphians were dead, with another 200,000 sick.” but may concatenate the sentences with an ellipsis following the first sentence, e.g., as “In just one year, 1918, the average life expectancy in America plummeted by a dozen years . . . . In just 10 days, over 1000 Philadelphians were dead, with another 200,000 sick.”, when the sentences meet the distance criteria/criterion. In some implementations, the extractive summary system 126 may provide the extractive summary 235 as an output, e.g., to the search result generator 124. The extractive summary 235 can be used in generating a search result for the resource 204.

The extractive summary system 126 may include a resource scorer 240 that is configured to generate a relevance score for the extractive summary 235, i.e., the extractive summary relevance score. The resource scorer 240 can be a service operated by the search system 120. In other words, in some implementations, the resource scorer 240 can be called by the 126 using the query 202 and the extractive summary 235 as input. The resource scorer 240 may consider and score the extractive summary 235 as a single resource (e.g., as a single document). Scoring the relevance of the extractive summary 235 to the query enables the search system 120 to take into account context provided by other passages in the resource, enabling the search system 120 to better (more often and more accurately) identify resources that answer the full complex query 202. Thus, the extractive summary relevance score may be used as a resource relevance score 245 in determining a search result page for the query 202. In other words, the extractive summary system 126 can provide a resource relevance score 245 used to re-rank (re-order) resources before determining the content of a search result page. The resource relevance score 245 can cause a resource previously not included in the top 10 responsive resources to be included in the top 10, or can cause a resource that was not the top-ranked resource to become the top-ranked resource.

Although illustrated as part of the extractive summary system 126 in FIG. 2, as discussed above, one or more components may be separate from the extractive summary system 126 but accessible to the extractive summary system 126, e.g., via an API call. For example, the extractive summary system 126 may use a relevant portion identifier 210, a sentence scorer 220, or a resource scorer 240 that is a service provided by the search system 120. Thus, for example, the resource scorer 240 may be used by the search result generator 124 to generate a relevance score that is used to initially rank the resources. Similarly, the relevant portion identifier 210 may be used by the search result generator 124 to identify a most relevant passage to use as a snippet in response to a factual query, etc. Put another way, the extractive summary system 126 may use existing processes for certain functions. In some implementations, the extractive summary 235 and/or the resource relevance score 245 generated for the query 202 and the resource 204 may be stored as a training example for training/fine tuning an extractive summary model.

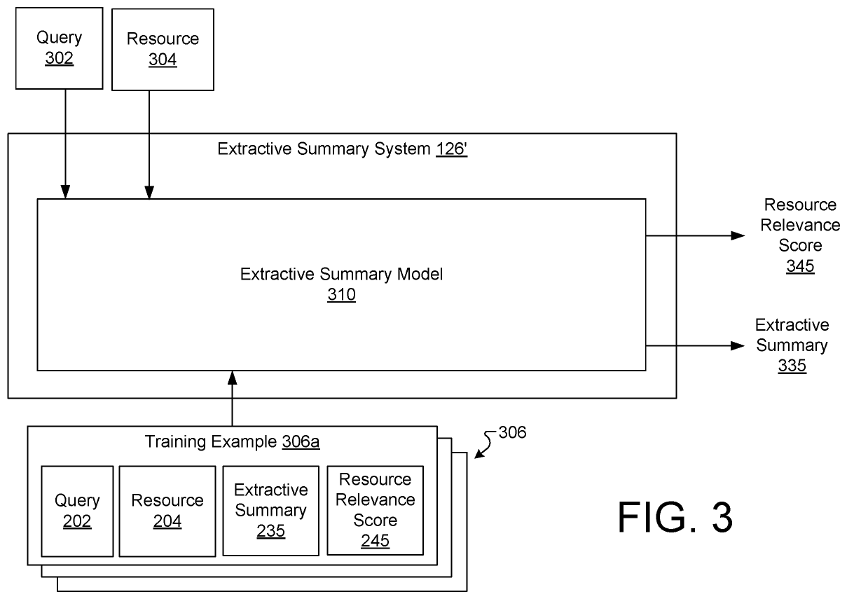

FIG. 3 is a diagram that illustrates another example extractive summary system 126′, according to disclosed implementations. In the example of FIG. 3, the extractive summary system 126′ includes extractive summary model 310. In the example of FIG. 3, the search system 120 is configured to generate training data 306 used to train the extractive summary model 310. The training data represents labeled training examples (e.g., 306a) from queries and resources processed by the extractive summary system 126 of FIG. 2. Thus, the training data 306 represents queries and resources with respective extractive summaries and/or resource relevance scores generated by the extractive summary system 126 of FIG. 2. In some implementations, the search system 120 may include both extractive summary system 126 and extractive summary system 126′.

The extractive summary system 126 of FIG. 2 may be too slow and consume too many computer resources to be done at scale (e.g., to be used to re-rank top-scoring resources for millions or billions of queries). Accordingly, in some implementations, the extractive summary system 126 of FIG. 2 may be used to respond to certain queries and the extractive summaries and relevance scores generated may be saved as training examples to train the extractive summary model 310, which can generate the extractive summary or relevance score based on the extractive summary much faster. In some implementations, the extractive summary system 126 of FIG. 2 may be used to respond to queries from a particular application, such as a voice assistant application, because the volume of queries received via the voice application is much smaller than the number of queries received via other sources (such as a browser-based search). In some implementations, the extractive summary system 126 of FIG. 2 may be used to respond to every m^{th} query. When the extractive summary system 126 of FIG. 2 is used to respond to a query 202, the query 202, the resource 204, the extractive summary 235 and/or the resource relevance score 245 generated for the extractive summary 235 may be stored as a training example 306a.

The training data 306 can be used to train the extractive summary model 310 to generate a resource relevance score 345 for a given query 302 and resource 304. The training data 306 can be used to train the extractive summary model 310 to generate an extractive summary 335 for a given query 302 and resource 304. The training data 306 can be used to train the extractive summary model 310 to provide the extractive summary 335 and the resource relevance score 345 for a given query 302 and resource 304. During training, the extractive summary model 310 can use the training data 306 to learn which sentences are most relevant to the query, and how to concatenate the sentences into an extractive summary. During training, the extractive summary model 310 can use the training data 306 to learn which sentences are most relevant to the query and how to score the sentences most relevant to the query, e.g., generating resource relevance score. During training, the extractive summary model 310 can use the training data 306 to learn which sentences are most relevant to the query, how to concatenate the sentences into an extractive summary and how to score the extractive summary to generate resource relevance score. This training may be used to generalize to other queries in inference mode. Thus, in an inference mode, the extractive summary model 310 may generate an extractive summary 335 and/or a resource relevance score 345 based on an extractive summary given the given query 302 and resource 304.

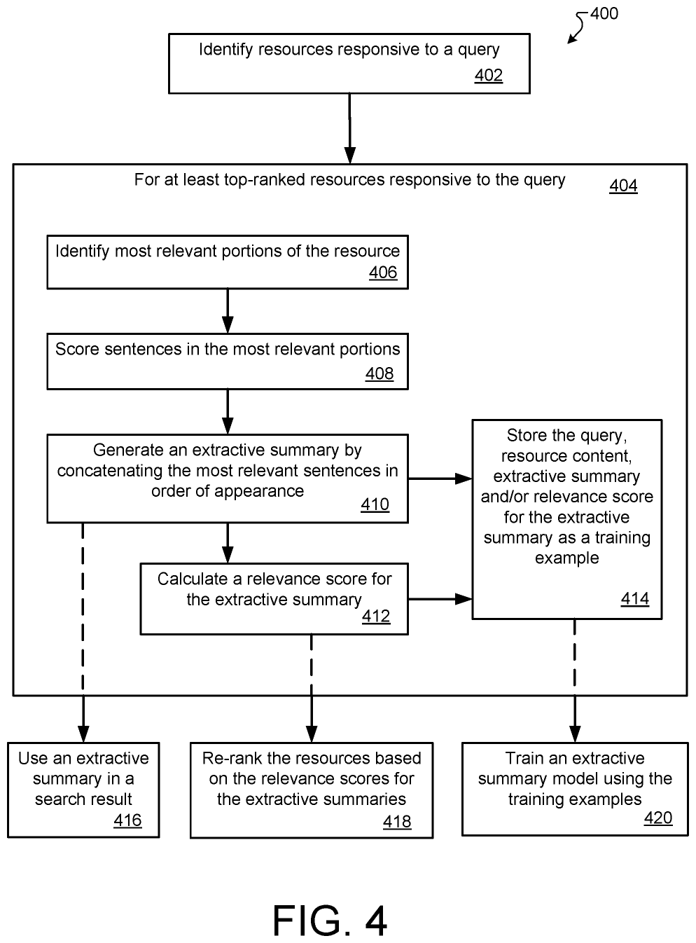

FIG. 4 is a diagram that illustrates an example method 400 for generating and using extractive summaries, according to disclosed implementations. Method 400 may be executed in an environment, such as environment 100. In some implementations, one or more of the method steps may be executed by a system, such as extractive summary system 126 of FIG. 2. In some implementations, one or more of the method steps may be executed by a model, such as extractive summary model 310 of FIG. 3. Not all steps need to be performed in some implementations. Additionally, the method steps can be performed in an order other than that depicted in FIG. 4.

At step 402, the system identifies (e.g., receives identifiers for) resources determined to be responsive to a query. For at least some of the top-ranked resources, at step 404, the system may generate an extractive summary, generate a relevance score for the extractive summary, and/or generate training examples for training an extractive summary model. More specifically, at step 406, the system may identify the most relevant portions of a resource. In some implementations, step 406 may be performed independently of step 404. In other words, the most relevant portions may have been identified as part of identifying the resources that are responsive to the query. At step 408, the system may score the sentences that appear in the most relevant portions. Put another way, each sentence in the most relevant portions may be given a sentence relevance score. The relevance represents relevance to the query.

At step 410, the system generates an extractive summary by concatenating the most relevant sentences. The sentences may be concatenated in an order in which the sentences appear in the resource. In some implementations, sentences which have a sentence relevance score that meets a threshold are included in the extractive summary. In some implementations, a maximum number (predetermined number) of sentences that have a relevance score that meets the threshold are used. In some implementations, sentences with similar relevance scores may be included. Thus, for example, a sentence with a 0.25 relevance score may be excluded because two or three other sentences have a 0.40, 0.45, and 0.49 relevance scores and are more tightly clustered. Put another way, the threshold can be determined based on a relevance score for the highest-ranked sentence for the resource. In some implementations, generating the extractive summary may include determining whether or not to include an ellipsis between two sentences. An ellipsis may be placed between two sentences when the sentences meet a distance criterion, such as being in different portions of the reference, being more than some number of words away from each other in the same portion, etc. In some implementations, the extractive summary may be used in a search result, e.g., at step 416. In some implementations, the extractive summary of the highest-ranked resource, or the highest-ranked resource after re-ranking using the relevance scores based on the extractive summaries (step 408), may be used in generating a search result page for the query. In some implementations, the extractive summary may be stored with the query and the resource (e.g., the resource content, an identifier for the resource, etc.) as a training example (step 414). Training examples can be used at step 420 to train a model to generate the extractive summary given the query and the resource.

At step 412, the system may calculate a relevance score for the extractive summary. The relevance score is based on the relevance of the extractive summary to the query. In some implementations, the extractive summary is treated as a resource and scored as a resource responsive to the query. The relevance score can be used as a resource relevance score to re-rank resources responsive to the query (e.g., at step 418). The re-ranking can cause a resource to be ordered ahead of another resource that was previously higher ranked. Put another way, the re-ranking can elevate resources that are most responsive to the query even if a highest scoring portion of that resource was not, by itself, most responsive to the query. In other words, the relevance score that is based on the extractive summary accounts for the relevance of multiple portions of a resource, rather than from a single portion, as in current ranking systems.

In some implementations, the relevance score calculated based on the extractive summary can be stored with the query and the resource as a training example (e.g., at step 414). In such an implementation, at step 420 the training examples are used to train an extractive summary model to generate a relevance score given the query and the resource and represents an improved ranking model because it can focus on more than one portion of a resource. Determining relevance based on all content of a resource is too computationally expensive to scale to billions of queries. The training examples that include a relevance score based on the extractive summary train the model to focus on certain passages and score those passages, rather than try to determine the relevance of every passage. In some implementations, both the extractive summary (from step 410) and the relevance score (from step 412) are stored with the query and the resource as a training example. Such training examples can be used at step 420 to make the model more efficient and can result in a model that can generate both the extractive summary and the relevance score that is based on the extractive summary.

In some implementations, the trained model may perform step 404. In other words, a model may be trained, in step 420, to perform step 404 given a query and a resource. Thus, the model may generate (output) a relevance score that is based on an extractive summary for a given resource and query and/or may generate (output) the extractive summary. In some implementations, training examples may be used to fine-tune, or further train, an operational model.

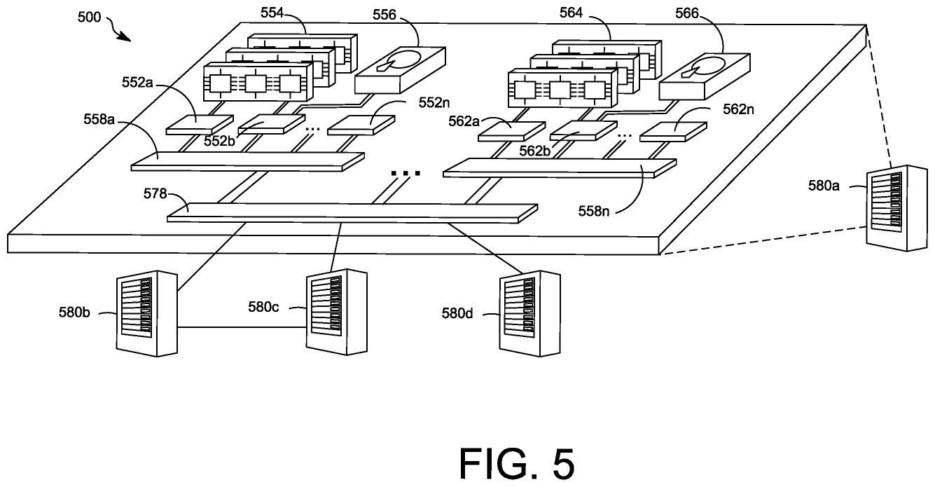

FIG. 5 shows an example of a computing device 500, which may be search system 120 of FIG. 1, which may be used with the techniques described here. Computing device 500 is intended to represent various example forms of large-scale data processing devices, such as servers, blade servers, datacentres, mainframes, and other large-scale computing devices. Computing device 500 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 500 may be a distributed system that includes any number of computing devices 580 (e.g., 580a, 580b, . . . 580n). Computing devices 580 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 580a includes multiple racks (e.g., 558a, 558b, . . . , 558n). Each rack may include one or more processors, such as processors 552a, 552b, . . . , 552n and 562a, 562b, . . . , 562n. The processors may include data processors, network attached storage devices, and other computer-controlled devices. In some implementations, one processor may operate as a master processor and control the scheduling and data distribution tasks. Processors may be interconnected through one or more rack switches 562a-562n, and one or more racks may be connected through switch 578. Switch 578 may handle communications between multiple connected computing devices 500.

Each rack may include memory, such as memory 554 and memory 564, and storage, such as 556 and 566. Storage 556 and 566 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 556 or 566 may be shared between multiple processors, multiple racks, or multiple computing devices and may include a non-transitory computer-readable medium storing instructions executable by one or more of the processors. Memory 554 and 564 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 554 may also be shared between processors 552a-552n. Data structures, such as an index, may be stored, for example, across storage 556 and memory 554. Computing device 500 may include other components not shown, such as controllers, buses, input/output devices, communications modules, etc.

An entire system may be made up of multiple computing devices 500 communicating with each other. For example, device 580a may communicate with devices 580b, 580c, and 580d, and these may collectively be known as extractive summary system 126, search result generator 124, indexing system 128, query processor 122, and/or search system 120. Some of the computing devices may be located geographically close to each other, and others may be located geographically distant. The layout of computing device 500 is an example only and the system may take on other layouts or configurations.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) LCD (liquid crystal display), or LED monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Moreover, as used herein, ‘a’ or ‘an’ entity may refer to one or more of that entity.

In some aspects, the techniques described herein relate to a method including: for each resource of a plurality of top-ranked resources that are responsive to a query: determining, for each sentence in at least some portions of the resource a relevance score for the sentence, generating an extractive summary for the resource from sentences with highest relevance scores, and determine an extractive summary relevance score for the extractive summary for the resource; re-rank the plurality of top-ranked resources based on the extractive summary relevance scores; and generate a search result for the query based at least in part on the re-ranking.

In some aspects, the techniques described herein relate to a method, wherein generating the search result for the query includes adding the extractive summary for a highest-ranked resource to a search result page for the query.

In some aspects, the techniques described herein relate to a method, wherein re-ranking causes a resource of the plurality of top-ranked resources to be ordered ahead of another resource of the plurality of resources.

In some aspects, the techniques described herein relate to a method, further including: training an extractive summary model by providing, for at least one resource of the plurality of top-ranked resources, the query, content of the at least one resource, and the extractive summary for the at least one resource as a training example for the extractive summary model.

In some aspects, the techniques described herein relate to a method, further including: training an extractive summary model by providing, for at least one resource of the plurality of top-ranked resources, the query, content of the at least one resource, and the extractive summary relevance score for the at least one resource as a training example for the extractive summary model.

In some aspects, the techniques described herein relate to a method, wherein generating the extractive summary includes: identifying sentences with relevance scores that meet a threshold, wherein the sentences with highest relevance scores are selected from the sentences with relevance scores that meet the threshold.

In some aspects, the techniques described herein relate to a method, wherein generating the extractive summary for the resource includes concatenating the sentences with highest relevance in an order in which the sentences appear in the resource.

In some aspects, the techniques described herein relate to a method, wherein generating the extractive summary for the resource includes: determining that a first sentence and a second sentence of the sentences with highest relevance meet a distance criterion; and adding an ellipsis after the first sentence before concatenating the second sentence.

In some aspects, the techniques described herein relate to a method including: for each resource of a plurality of resources that are responsive to a query: providing the query and content of the resource to an extractive summary model, and obtaining a relevance score for the resource from the extractive summary model, the extractive summary model trained to provide the relevance score based on an extractive summary for the resource rather than a highest ranked portion of the resource; rank the plurality of resources based on the extractive summary relevance scores; and generate a search result for the query based at least in part on the ranking.

In some aspects, the techniques described herein relate to a method, wherein the extractive summary model provides a relevance score for a resource in less than 5 ms.

In some aspects, the techniques described herein relate to a method, further including: determining that the query is not a factual query, wherein obtaining the relevance scores from the extractive summary model and ranking the plurality of resources occur responsive to determining that the query is not a factual query.

In some aspects, the techniques described herein relate to a method, further including: obtaining the extractive summary from the extractive summary model; and adding the extractive summary for a highest-ranked resource to a search result page for the query.

In some aspects, the techniques described herein relate to a method including: for each resource of a plurality of resources that are responsive to a first query: determining, for each sentence in at least some portions of the resource a relevance score for the sentence, generating an extractive summary for the resource from sentences with highest relevance scores, determine an extractive summary relevance score for the extractive summary for the resource, and storing the extractive summary relevance score, the extractive summary, the first query, and the resource as a training example; training a model to provide a relevance score as output using the training examples; and using the model to determine a resource with highest relevance to a second query.

In some aspects, the techniques described herein relate to a method, wherein training the model further includes training the model to provide an extractive summary and the relevance score as output.

In some aspects, the techniques described herein relate to a method, further including: using the model to obtain an extractive summary for the resource with highest relevance to the second query; and adding the extractive summary to a search result page for the second query.

1. A computer-implemented method comprising:
by at least one processor, and for each resource of a plurality of top-ranked resources that are responsive to a complex query:
determining, for each sentence in at least some portions of the resource a relevance score for the sentence with respect to the complex query,
generating an extractive summary for the resource from sentences with highest relevance scores by concatenating the sentences with highest relevance in an order in which the sentences appear in the resource, and
determining an extractive summary relevance score for the extractive summary, the extractive summary relevance score reflecting a relevance of the extractive summary to the complex query;
re-ranking, by the at least one processor, the plurality of top-ranked resources based on the extractive summary relevance scores of the top-ranked resources; and
generating by the at least one processor, a search result page for the complex query based at least in part on the re-ranking, wherein the re-ranking causes at least one search result for a resource of the plurality of top-ranked resources with a first relevance score to be ordered ahead of a search result for another resource of the plurality of top-ranked resources with a second relevance score that is higher than the first relevance score.

2. The computer-implemented method of claim 1, wherein generating the search result page includes adding the extractive summary for a-highest-ranked resource to the search result page.

3. The computer-implemented method of claim 1, wherein an answer to the complex query is not satisfied by a stored attribute about an entity.

4. The computer-implemented method of claim 1, further comprising:
training an extractive summary model by providing, for at least one resource of the plurality of top-ranked resources, the complex query, content of the at least one resource, and the extractive summary for the at least one resource as a training example for the extractive summary model.

5. The computer-implemented method of claim 1, further comprising:
training an extractive summary model by providing, for at least one resource of the plurality of top-ranked resources, the complex query, content of the at least one resource, and the extractive summary relevance score for the at least one resource as a training example for the extractive summary model.

6. The computer-implemented method of claim 1, wherein generating the extractive summary includes:
identifying sentences with relevance scores that meet a threshold,
wherein the sentences with the highest relevance scores are selected from the sentences with relevance scores that meet the threshold.

7. The computer-implemented method of claim 6, wherein generating the extractive summary for the resource comprises:
determining that a first sentence and a second sentence of the sentences with highest relevance are separated by more than a minimum number of words in a same portion of the resource; and
adding an ellipsis after the first sentence before concatenating the sentences.

8. The computer-implemented method of claim 6, wherein
generating the extractive summary for the resource comprises:
determining that a first sentence and a second sentence of the sentences with highest relevance appear in different portions of the resource; and
adding an ellipsis after the first sentence before concatenating the second sentence.

9. A computer-implemented method comprising:
by at least one processor, and for each resource of a plurality of resources that are responsive to a complex query, each resource of the plurality of resources having a first type of relevance score reflecting a relevance of a top-scoring portion of the resource:
identifying top-ranked resources from the plurality of resources by:
providing the complex query and content of the resource to an extractive summary model, and
obtaining a second type of relevance score for the resource from the extractive summary model, the extractive summary model trained to provide the second type of relevance score based on an extractive summary for the resource rather than a highest ranked portion of the resource, the second type of relevance score being configured to reflect a hierarchical structure of information relevant to the complex query from the resource;
rank, by the at least one processor, the top-ranked resources based on the second type of relevance scores; and
generate, by the at least one processor, a search result page for the complex query based at least in part on the ranking.

10. The computer-implemented method of claim 9, wherein the extractive summary model provides a second relevance score for a resource in less than 5 ms.

11. The computer-implemented method of claim 9, further comprising:
determining that a received query is a complex query,
wherein obtaining the second type of relevance scores from the extractive summary model and ranking the plurality of resources occur responsive to determining that the received query is a complex query.

12. The computer-implemented method of claim 9, further comprising:
obtaining, for a resource, the extractive summary with the first type of relevance score from the extractive summary model; and
adding the extractive summary for a highest-ranked resource to the search result page for the complex query.

13. A computer-implemented method comprising:
by at least one processor, and for each resource of a plurality of resources that are responsive to a first complex query:
determining, for each sentence in at least some portions of the resource a first type of relevance score for the sentence reflecting a relevance of a top-scoring portion of the resource to the first complex query,
generating an extractive summary for the resource from sentences with highest relevance scores by concatenating the sentences with highest relevance in an order in which the sentences appear in the resource,
determining a second type of relevance score for the extractive summary for the resource, the second type of relevance score reflecting a relevance of the extractive summary to the first complex query, and
storing the second type of relevance score, the extractive summary, the first complex query, and the resource as a training example;
training, by the at least one processor, a model to provide the second type of relevance score for a query as output using the training examples; and
using, by the at least one processor, the model to determine a resource with highest relevance to a second complex query.

14. The computer-implemented method of claim 13, wherein training the model further includes training the model to provide the extractive summary with the second type of relevance score as the output.

15. The computer-implemented method of claim 14, further comprising:
using the model to obtain the extractive summary for the resource with a highest second type of relevance to the second complex query; and
adding the extractive summary to a search result page for the second complex query.

16. The computer-implemented method of claim 1, wherein the extractive summary captures a hierarchical structure of information responsive to the complex query.
